(19) United States
(12) Patent Application Publication
(10) Pub. No.: US 2010/0199271 A1
(43) Pub. Date: Aug. 5, 2010

(54) ELECTRONIC APPARATUS, UPDATING METHOD OF SOFTWARE AND STORAGE MEDIUM STORING COMPUTER PROGRAM

(75) Inventor: Takuto Harada, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/695,974

(22) Filed: Jan. 28, 2010

(30) Foreign Application Priority Data
Jan. 30, 2009 (JP) 2009-020515

(51) Int. Cl. G06F 9/44

(52) U.S. Cl. 717/168; 717/172

(57) ABSTRACT

An electronic apparatus including a software module includes a setting unit configured to set information indicative of a policy at the time of updating the software module based on an operation by a user, an acquirement unit configured to acquire the software module to be updated and information as an index for determining timing for updating the software module and a determination unit configured to determine the timing for updating the software module by using the information set by the setting unit and the information acquired by the acquirement unit.

### BACKGROUND OF THE INVENTION

1. Field of the Invention

The present invention relates to an electronic apparatus, an updating method of software and a computer program.

2. Description of the Related Art

Japanese Patent Laid-open No. 07-129407 discusses a technique that, when a program version of a client terminal differs from a program version of a server, a user is encouraged to determine whether or not the version of the program of the client terminal is to be updated.

Further, Japanese Patent Laid-open No. 11-161482 discusses a technique in which, when a fault that has occurred in the electronic apparatus is stored and distributed software corrects the stored fault, the software is updated.

### SUMMARY OF THE INVENTION

According to an aspect of the present invention, an electronic apparatus including a software module which further includes a setting unit configured to set information indicative of a policy at the time of updating the software module based on an operation by a user, an acquirement unit configured to acquire the software module to be updated and information as an index for determining timing for updating the software module and a determination unit configured to determine the timing for updating the software module by using the information set by the setting unit and the information acquired by the acquirement unit.

Further features and aspects of the present invention will become apparent from the following detailed description of exemplary embodiments with reference to the attached drawings, in which like reference characters designate the same or similar parts throughout thereof.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of a software distribution system according to an exemplary embodiment of the present invention.

FIG. 2 illustrates an example of configurations of a server and a software module of a multifunctional peripheral (MFP), respectively, according to the exemplary embodiment of the present invention.

FIG. 3 illustrates an example of a data structure of update information according to the exemplary embodiment of the present invention.

FIG. 4 illustrates an example of a structure of data of function use frequency according to the exemplary embodiment of the present invention.

FIG. 5A illustrates an example of a graphical user interface (GUI) which is displayed on a user interface (UI) when an operation to set timing or a policy for updating a software module is started according to the exemplary embodiment of the present invention.

FIG. 5B illustrates an example of the GUI which is displayed on the UI when a user clicks a manual mode button of FIG. 5A according to the exemplary embodiment of the present invention.

FIG. 5C illustrates an example of the GUI which is displayed on the UI when the user clicks a policy setting button of FIG. 5A according to the exemplary embodiment of the present invention.

FIG. 6 illustrates an example of a data structure of update timing information according to the exemplary embodiment of the present invention.

FIG. 7 is a flow chart illustrating an example of an operation of the MFP when the timing, at which the software module is updated, is determined according to the exemplary embodiment of the present invention.

FIG. 8 is a schematic view illustrating an example of a creating process of the update timing information when the user desires to set the updating of a software module group by a manual operation according to the exemplary embodiment of the present invention.

FIG. 9 is a flow chart illustrating an example of a creation method of the update timing information when the user desires to set the updating of the software module group by the manual operation according to the exemplary embodiment of the present invention.

FIG. 10 is a schematic view illustrating an example of a creation process of the update timing information when the user desires to set the updating of the software module group according to a policy setting according to the exemplary embodiment of the present invention.

FIG. 11 is a flow chart illustrating an example of a creation method of the update timing information when the user desires to set the updating of the software module group according to the policy setting according to the exemplary embodiment of the present invention.

### DESCRIPTION OF THE EMBODIMENTS

Various exemplary embodiments, features, and aspects of the invention will be described in detail below with reference to the drawings.

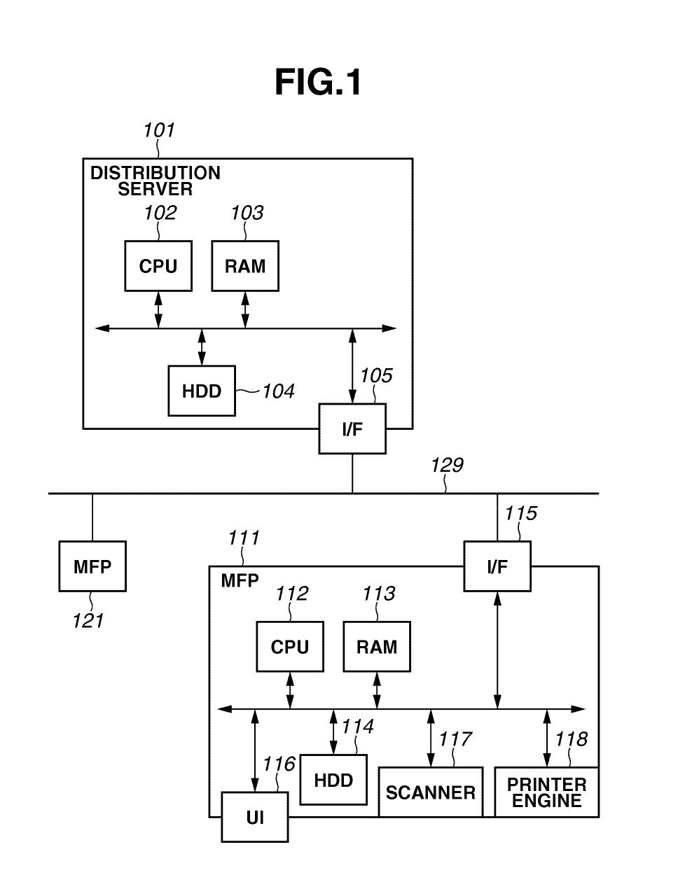

FIG. 1 illustrates an example of a configuration of a software distribution system.

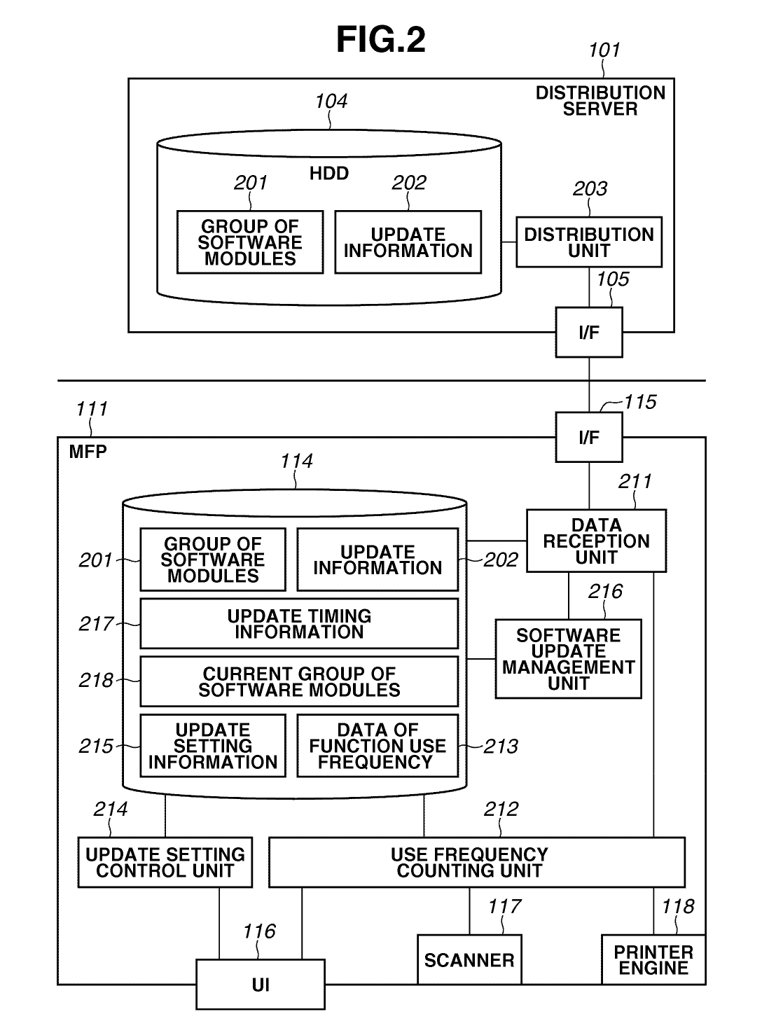

In FIG. 1, a distribution server 101 includes a central processing unit (CPU) 102. All the software executed by the distribution server 101 among the software described in FIG. 2 and the following figures run on the CPU 102. The distribution server 101 also includes a random access memory (RAM) 103. The RAM 103 is used in a case where the software running on the CPU 102 stores data and where the software itself runs on the CPU 102. The distribution server 101 further includes a hard disk drive (HDD) 104 which stores the software and the like. The distribution server 101 still further includes a communication interface 105.

A multifunction peripheral (MFP) 111 includes a central processing unit (CPU) 112. All the software executed by the MFP 111 of the software described in FIG. 2 and the following figures run on the CPU 112. The MFP 111 also includes random access memory (RAM) 113 which is used in a case where the software running on the CPU 112 stores data and where the software itself runs on the CPU 112. The MFP further includes a hard disk drive (HDD) 114 which stores the software and the like, a communication interface 115, a user interface (UI) 116 through which the user makes an operation and by which a result of the operation is displayed, a scanner 117 and a printer engine 118.

A configuration of hardware of a multifunction peripheral (MFP) 121 is identical to that of a hardware of the MFP 111, so that the configuration is not shown in FIG. 1. Also, in the following description, a software module is distributed from the distribution server 101 to the MFP 111 as an example; however, the software module can also be distributed from the distribution server 101 to the MFP 121.

FIG. 2 illustrates an example of a configuration of the software module of the distribution server 101 and the MFP 111.

In FIG. 2, a group of software modules 201 is distributed from the distribution server 101 to the MFP 111. Update information 202 includes an update content of the group of software modules 201 and necessary processing for performing the updating. The update information 202 is created by a provider (user) when the provider creates the group of software modules 201.

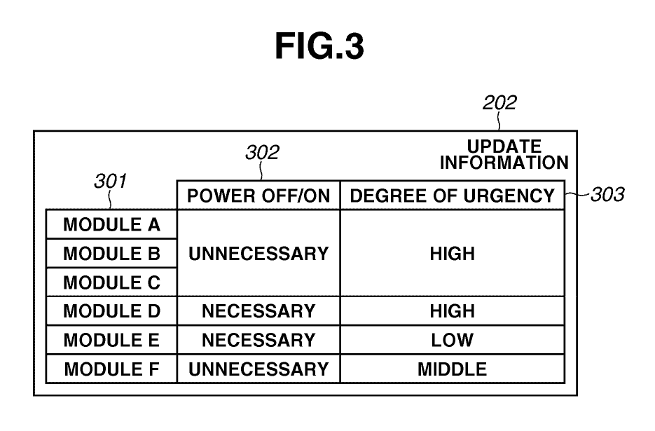

FIG. 3 illustrates an example of a data structure of the update information 202. In FIG. 3, the update information 202 includes names of the software modules (module name) 301 which realize functions of the MFP 111. For example, a module A performs copying and a module D creates page description language (PDL) data. In other words, each of the software modules has a unique function.

The update information 202 also includes a power OFF/ON necessity 302 which represents whether or not the MFP 111 is to be turned on (ON) after once the MFP 111 is turned off (OFF) (i.e., is turned OFF/ON) when the software module of a name listed in the module name 301 is updated. The update information 202 further includes a degree of urgency 303 to update the software module having the name represented in the list of the module name 301. For example, the degree of urgency 303 of the updating becomes higher in a case where the software module is corrected in order to recover a serious fault which has occurred in the MFP 111 and where a new function extremely effective to the user is added to the software module.

As described above, the degree of urgency 303 of the updating is the information indicative of a materiality of the fault to be treated by the updating and a usefulness of the updating. Further, in the example as illustrated in FIG. 3, the power OFF/ON necessity 302 and the degree of urgency 303 of the updating of the module A through the module Care combined and indicated in the form of single information. This means that the module A through the module C are to be updated concurrently (together).

Returning to FIG. 2, a distribution unit 203 distributes the group of software modules 201 and the update information 202 to the MFP 111 through a network 129 which connects the distribution unit 203 to the MFP 111 to each other.

A data reception unit 211 receives data distributed from the distribution unit 203 of the distribution server 101 and stores the data in the HDD 114. A use frequency counting unit 212 counts a use frequency of the function of the MFP 111. The use frequency counting unit 212 holds the data of thus counted use frequency in the HDD 114 as the data of function use frequency 213.

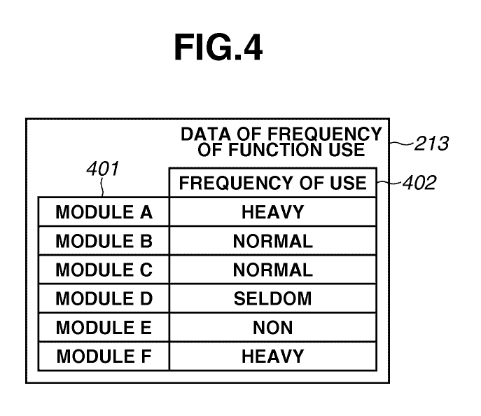

FIG. 4 illustrates an example of a data structure of the data of function use frequency 213.

In FIG. 4, the data of function use frequency 213 includes names of software modules (module name) 401 which realize the functions of the MFP 111. The data of function use frequency 213 also includes a use frequency 402 of the software modules which are listed in the module name 301. In FIG. 4, the use frequency 402 of the module F is indicated as “NONE”, which represents that the module F has not been used yet. As described above, in the present exemplary embodiment, an example of an acquirement unit is realized by the data reception unit 211 receiving the group of software modules 201 and the update information 202 and by the use frequency counting unit 212 counting the use frequency in the MFP 111.

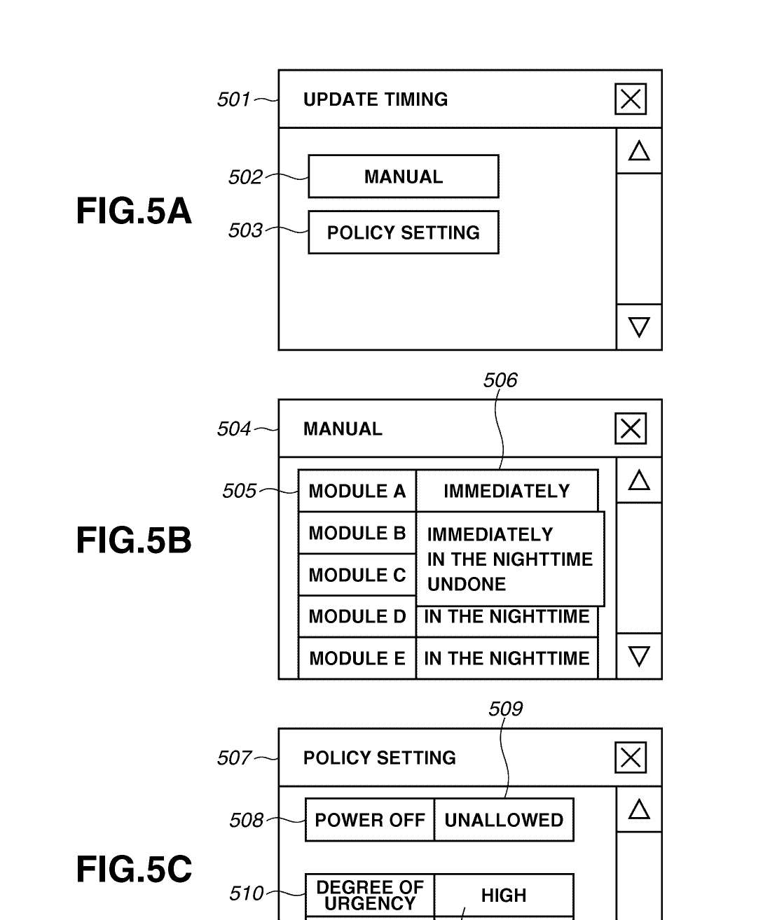

An update setting control unit 214 displays a Graphical User Interface (GUI) of FIG. 5 on a display as one of the user interfaces (UIs) 116 and sets a timing, at which the group of software modules 201 achieving the functions of the MFP 111 are updated, and a policy of the updating. The update setting control unit 214 holds in the HDD 114 the information set according to an operation by the user based on the GUI displayed on the display in the form of update setting information.

FIG. 5 illustrates an example of the GUI that the update setting control unit 214 displays on the display. More specifically, FIG. 5A illustrates an example of the GUI which is displayed on a user interface (UI) 116 when an operation to set the update policy and timing for updating the software module is started (when the update setting control unit 214 is activated). FIG. 5B illustrates an example of the GUI which is displayed on the UI 116 when the user clicks a manual mode button of FIG. 5A. FIG. 5C illustrates an example of the GUI which is displayed on the UI 116 when the user clicks a policy setting button of FIG. 5A.

FIG. 5A illustrates a graphical user interface (GUI) 501 at the time when the update setting control unit 214 is activated. The GUI 501 displays the manual mode button 502 and the policy setting button 503. The manual mode button 502 is clicked by the user when the user sets the update timing at which the software is updated, at his discretion. The policy setting button 503 is clicked by the user when the user sets only a basic policy for updating the software module.

When the user clicks the manual mode button 502, the GUI 504 of FIG. 5B is displayed on the display.

In FIG. 5B, names of the software modules (module name) 505 are names of the software modules which realize the functions of the MFP 111. A select button 506 sets the update timing for updating the software module having a name listed in the module name 505. In the example of FIG. 5B, the user clicks the select button 506 of the module A, and therefore, options of “immediately”, “in the nighttime” and “undone” are illustrated in the form of a pull-down menu. The user selects the update timing for updating the software module from the pull-down menu.

When the user clicks the policy setting button 503, a GUI 507 of FIG. 5C is displayed on the display.

In FIG. 5C, a parameter 508 is indicative of a power OFF state. When the user clicks a button 509, a pull-down menu, which includes options whether to allow the MFP 111 to be turned off (“allowed”) or not to allow the MFP 111 to be turned off (“unallowed”) when the software module is updated, is displayed in order for the user to select either one of the above options. The user selects from the pull-down menu whether or not he allows the MFP 111 to be turned off when the software module is updated. In the example as illustrated in FIG. 5C, a state that “unallowed” is selected is illustrated.

A parameter 510 indicates a degree of urgency. When the user clicks a button 511, an option of the degree of urgency which is set to the urgency degree 303 of the updating contained in the update information 202 of FIG. 3 and a symbol “-” indicating that an updating timing can be set at any time, are displayed in the form of the pull-down menu. The user selects from the pull-down menu the urgency degree of updating the software module and sets a level of urgency degree for updating. In the example as illustrated in FIG. 5C, a “high” indicative of the highest degree of urgency of updating the software module is selected.

A parameter 512 indicative of the use frequency is illustrated in FIG. 5C. When the user clicks a button 513, an option of the use frequency which is set to the use frequency 402 contained in the data of function use frequency 213 of FIG. 4 and an option of a symbol “-” indicating that the use frequency of the software module can be at any level are displayed in the form of the pull-down menu. The user selects the use frequency of the software module from the pull-down menu and sets the level of the use frequency of the software module which the user desires to update as soon as possible. In the example as illustrated in FIG. 5C, the symbol “-” indicating a state that the use frequency of the software module to be updated is selected.

Selectable portions of the GUI 504 and the GUI 507 of FIG. 5 include default values, and therefore, the default values become effective if the user does not provide the operation. The above described setting values are held by the update setting information 215.

Returning to FIG. 2, a software update management unit 216 controls the updating of the group of software modules 201. The software update management unit 216 determines the timing at which the group of software modules 201 is updated, with reference to the update information 202, based on the update setting information 215 and the data of function use frequency 213. The software update management unit 216 holds the timing at which the group of software modules 201 is updated, in the HDD 114 as the update timing information 217. A group of software modules 218 is currently running on the present system.

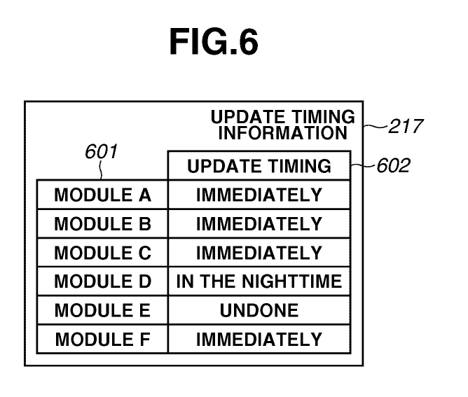

FIG. 6 illustrates an example of a data structure of the update timing information 217.

In FIG. 6, the update timing information 217 includes names of the software modules (module name) 601 which realize the functions of the MFP 111. The update timing information 217 further includes timings (update timing) 602 for updating the software modules of the names listed in the module name 505.

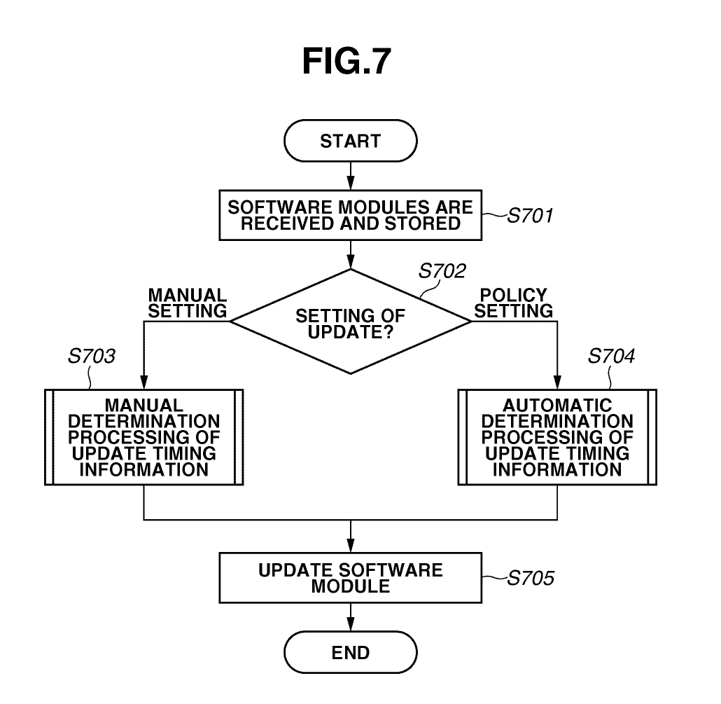

FIG. 7 is a flow chart illustrating an example of an operation of the MFP 111 when the update timing for updating the software module is determined.

When the data reception unit 211 receives the group of software modules 201 and the update information 202 which are distributed from the distribution server 101, the data reception unit 211 stores thus received group of software modules 201 and the update information 202 in the HDD 144. In step S701, the data reception unit 211, subsequently, issues a request to the software update management unit 216 so as to create the update timing information 217.

In step S702, the software update management unit 216 refers to the update setting information 215 which is asynchronously set, to determine whether the user desires to perform the updating by a manual operation or based on its policy. In other words, the software update management unit 216 determines if the user clicks the manual mode button 502 in order to perform the setting based on the GUI 504 or if the user clicks the policy setting button 503 in order to perform the setting based on the GUI 507.

As described above, in the present exemplary embodiment, an example of setting unit can be realized by holding the update setting information 215 in the HDD 114.

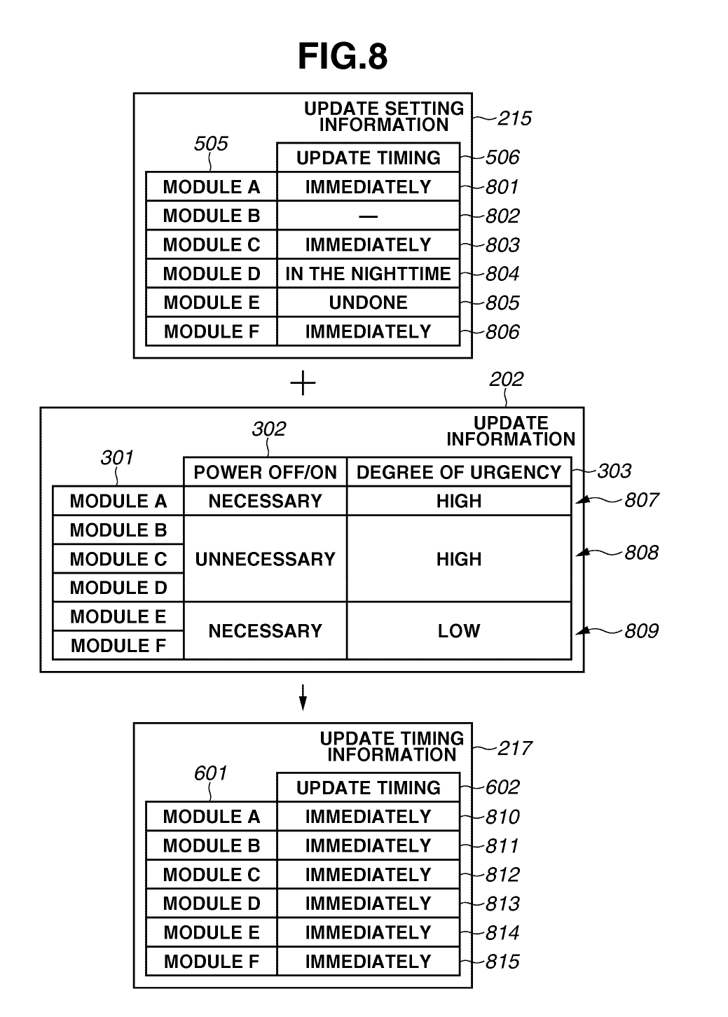

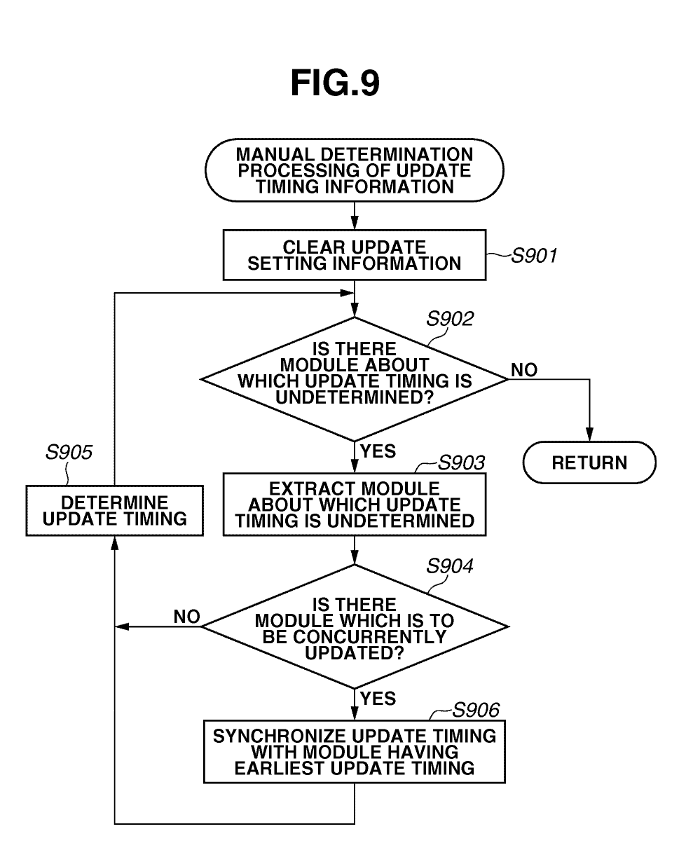

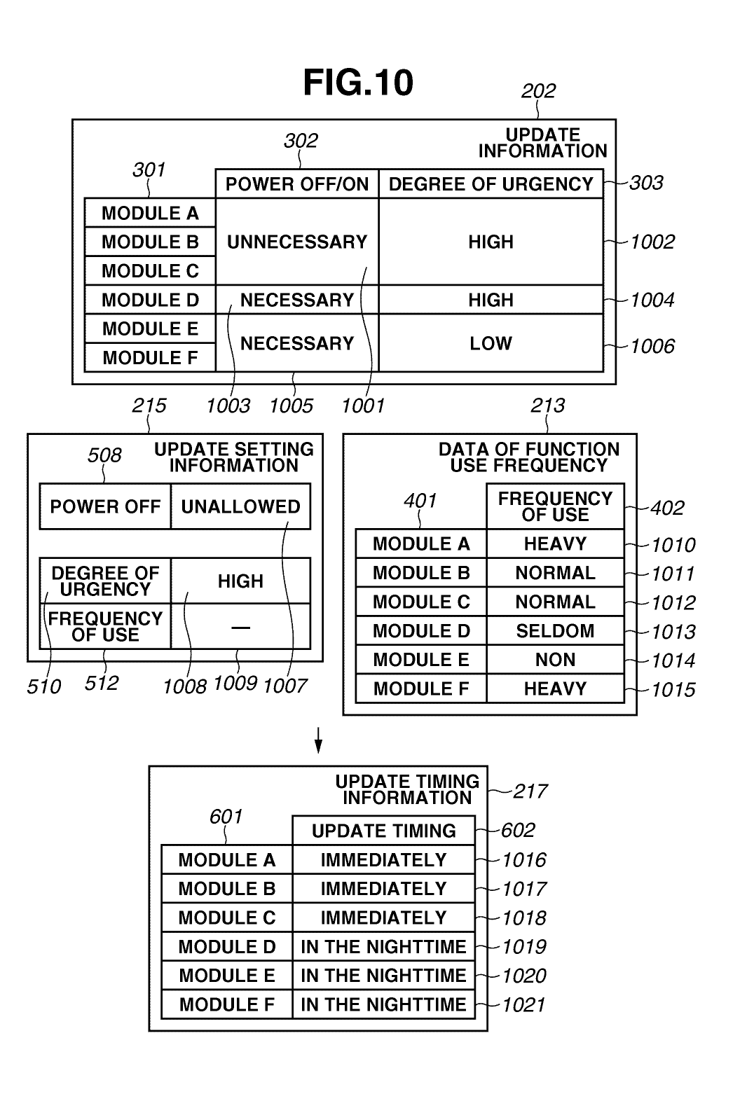

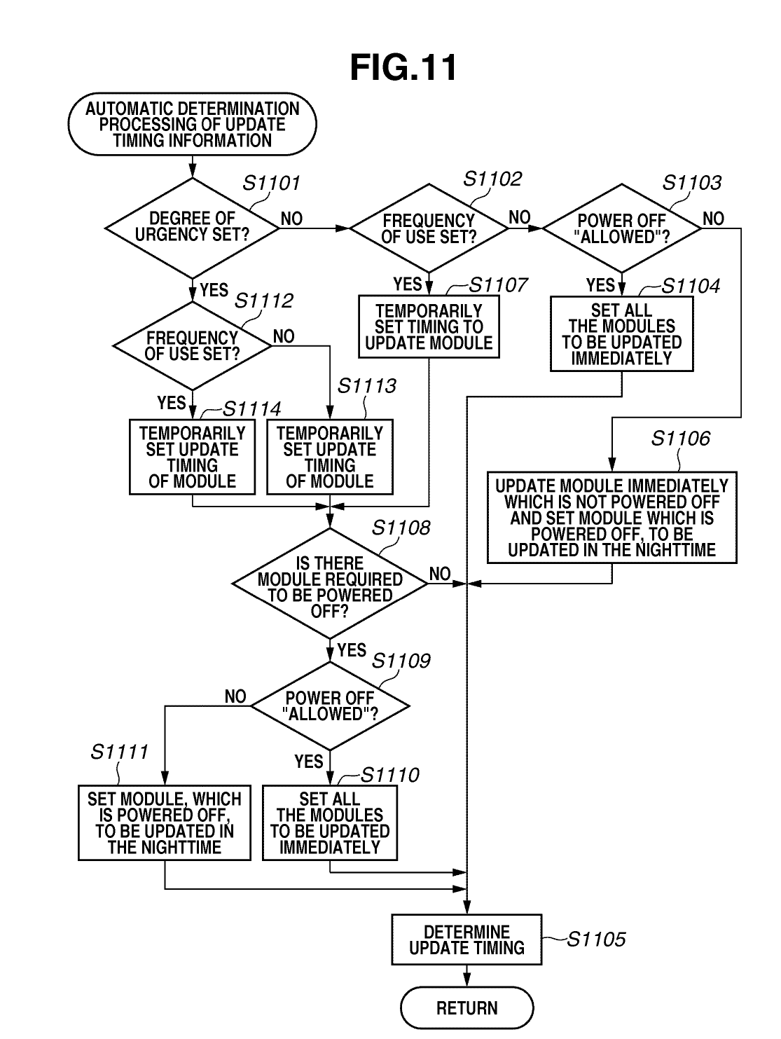

In step S703, when the software update management unit 216 determines that the user desires to manually perform the updating, the software update management unit 216 determines the update timing information 217 based on a method referring to a schematic view of FIG. 8 and a flow chart of FIG. 9. In step S704, on the other hand, when the software update management unit 216 determines that the user desires to perform the updating based on the policy, the software update management unit 216 determines the update timing information 217 based on a method referring to a schematic view of FIG. 10 and a flow chart of FIG. 11.

In step S705, the software update management unit 216 performs the updating of the software module based on the update timing information 217 determined in step S703 or step S704.

FIG. 8 schematically illustrates an example of a creation processing of the update timing information 217 in the case where the user desires to set the updating of the group of software modules 201 by the manual operation. In this case, the update setting information 215 and the update information 202 are set as illustrated in FIG. 8.

In FIG. 8, the update setting information 215 includes examples of the update timings 801 through 806 which are set as the update setting information 215. Update timings 801, 803 and 806 indicate the user has given an instruction that immediate updating of the modules A, C and F is to be performed (in FIG. 8, represented by “immediately”). An update timing 802 indicates the user has given an instruction that the updating of the module B may be performed at any time (in FIG. 8, represented by “-”). An update timing 804 indicates the user has given an instruction that the updating of the module D is to be performed in the nighttime (in FIG. 8, represented by “in the nighttime”). An update timing 805 indicates the user has given an instruction that the updating of the module E is not to be performed (in FIG. 8, represented by “undone”).

The update information 202 includes examples 807 through 809 of the software modules. When the software modules are manually updated, the following information will be required. Information indicating that a plurality of software modules set in the update information 202 can be updated independently or are required to be updated concurrently with the other software modules becomes necessary. In an example of FIG. 8, the update information 202 includes information indicating that the module A can be updated independently (update information 807). The update information 202 includes information indicating that the module B, the module C and the module D are required to be updated at the same time (update information 808). Further, the update information 202 includes information indicating that the module E and the module F are required to be updated at the same time (update information 809).

Update timings 810 through 815 (definitive values) of the respective software are timings which are derived, based on an algorithm of FIG. 9, from states of the update information 807 through 809 and the update timings 801 through 806 which are designated by the user. The update timings 810 through 812, 814 and 815 indicate that the modules A, B, C, E and F are to be immediately updated (in FIG. 8, represented by “immediately”). Further, the update timing 813 indicates that the module D is to be updated in the nighttime (in FIG. 8, represented by “in the nighttime”).

FIG. 9 is a flow chart illustrating an example of a creation method for creating the update timing information 217 when the user desires to set the group of software modules 201 by the manual operation. The flow chart of FIG. 9 illustrates in detail an example of the manual determination processing of the update timing information of step S704 of FIG. 7.

In step S901, the software update management unit 216 clears the update timing 602 of the software module which has already been set in the update timing information 217.

In step S902, the software update management unit 216 determines whether or not there is a software module about which update timing 602 is not determined. As a result of the determination, if there is a software module about which update timing 602 has not been determined yet (YES in step S902), the processing goes to step S903.

In step S903, the software update management unit 216 refers to the update information 202 in order to extract the name of the software module (module name 301).

In step S904, the software update management unit 216 conducts a search as to whether or not there is a software module which can be updated concurrently with the software module extracted in step S903 with reference to the update information 202. If the software module extracted in step S903 is the module A, the software update management unit 216 determines that there is no software module which can be concurrently updated (can be updated independently) since the update information 807 of FIG. 8 is set. If the software module extracted in step S903 is either one of the module B, the module C or the module D, the software update management unit 216 determines that there is the software module which can be concurrently updated since the update information 808 of FIG. 8 is set. Similarly, if the software module extracted in step S903 is either one of the module E or the module F, the software update management unit 216 determines that there is the software module which can be concurrently updated since the update information 809 of FIG. 8 is set.

As a result of the determination of step S904, if there is no software module which can be updated concurrently with the software module extracted in step S903 (NO in step S904), the processing goes to step S905. The software update management unit 216 sets the information selected by the select button 506 to the software module extracted in step S903 as the update timing 602 of the software module, thereby determining the update timing of the software module. A description is made below about the module A of FIG. 8. The update timing 801 designated by the user is set to the update timing 810 of the update timing information 217, thereby determining the update timing.

On the other hand, as a result of the determination in step S904, if there is a software module which can be updated concurrently with the software module extracted in step S903 (YES in step S904), the processing goes to step S906. Then, the software update management unit 216 selects the earliest update timing in the update timings designated by the user with respect to the software modules which can be updated concurrently with the software module extracted in step S903. The software update management unit 216 sets the selected update timing as the update timing 602 of the software module which can be concurrently updated, thereby determining the update timing. A description is made below about the module B of FIG. 8. The update timings 802, 803 and 804, which are designated by the user, are compared to one another and the update timing 803, which is the earliest update timing in the update timings 802, 803 and 804, is set as the update timings 811, 812 and 813 of the update timing information 217.

In step S902, the above described processing from steps S903 through S906 are repeated until no software module, about which update timing 602 is not determined, is found. When no software module, about which update timing 602 is not determined, is found (NO in step S902), the processing goes to step S706 of FIG. 7.

FIG. 10 schematically illustrates an example of a creation processing of the update timing information 217 when the user desires to set the update timing of the group of software modules 201 by the policy setting. The update setting information 215, update information 202 and the data of function use frequency 213 are set as an example in a manner as illustrated in FIG. 10.

In FIG. 10, the update information 202 of the respective software modules includes examples 1001 through 1006.

In the examples of FIG. 10, the module A, the module B and the module C are required to be concurrently updated. The power OFF/ON necessity 1001 of each of the module A, the module B and the module C is “unnecessary” and the degree of urgency 1002 of each of the module A, the module B and the module C is “high”.

The module D can be updated independently. A power OFF/ON necessity 1003 of the module D indicates “necessary” and a degree of urgency 1004 of the module D indicates “high”.

The module E and the module F are required to be concurrently updated. A power OFF/ON necessity 1005 of each of the module E and the module F indicates “necessary” and a degree of urgency 1006 of each of the module E and the module F indicates “low”.

The update setting information 215 includes examples 1007 through 1009 of a parameter 508 indicating the power OFF state, a parameter 510 indicating the degree of urgency and a parameter 512 indicating the use frequency, which are set as the update setting information 215.

In the examples of FIG. 10, the parameter 1007 of the power OFF state indicates “unnecessary”, the parameter 1008 of the degree of urgency indicates “high”, and the parameter 1009 of the use frequency indicates “-” (i.e., ignore).

The data of function use frequency 213 of the software modules includes examples 1010 through 1015.

In the examples of FIG. 10, the data of function use frequency 1010 of the module A indicates “high”, the data of function use frequency 1011 of the module B indicates “middle” and the data of function use frequency 1012 of the module C indicates “middle”, respectively. Further, the data of function use frequency 1013 of the module D indicates “low”, data of function use frequency 1014 of the module E indicates “non” and data of function use frequency 1015 of the module F indicates “high”, respectively.

Update timings 1016 through 1021 (definitive values) of the software modules are the timings which are derived, based on an algorithm of FIG. 11, from the update timing information 217, the update setting information 215 and data of function use frequency 213. The update timings 1016 through 1018 indicate that the module A, the module B and the module C are to be immediately updated (in FIG. 10, represented by “immediately”). Further, the update timings 1019 through 1021 indicate that the module D, the module E and the module F are to be updated in the nighttime (in FIG. 10, represented by “in the nighttime”).

FIG. 11 is a flow chart illustrating an example of a creation method of the update timing information 217 when the user desires to set the group of software modules 201 by its policy setting. The flow chart of FIG. 11 describes in detail the example of the automatic determination processing of the update timing information of FIG. 7.

In step S1101, the software update management unit 216 determines whether or not the parameter 510 of the degree of urgency is set as the update setting information 215. As a result of the determination, the processing goes to step S1112 if the parameter 510 of the degree of urgency is set (YES in step S1101).

On the other hand, if the parameter 510 of the degree of urgency is not set (NO in step S1101), the processing goes to step S1102. In step S1102, the software update management unit 216 determines whether or not the parameter 512 of the use frequency is set as the update setting information 215. As a result of the determination, the processing goes to step S1107 if the parameter 512 of the use frequency is set (YES in step S1102).

On the other hand, the processing goes to step S1103 if the parameter 512 of the use frequency is not set (NO in step S1102). In step S1103, the software update management unit 216 determines whether or not the parameter 508 of the power OFF state set as the update setting information 215 is indicated by “allowed”.

As a result of the determination, the processing goes to step S1106, which will be described later, if the parameter 508 of the power OFF state is not “allowed” (in a case of “unallowed”) (NO in step S1103). On the other hand, the processing goes to step S1104 if the parameter 508 of the power OFF state is “allowed” (YES in step S1103). In step S1104, the software update management unit 216 changes the update timing 602 with respect to all of the software modules 601 listed in the update timing information 217 to “immediately”. In step S1105, the software update management unit 216 determines the update timing according to a content of change and the processing goes to step S706.

In step S1103, as described above, when the software update management unit 216 determines that the parameter 508 of the power OFF state is not “allowed” (determines that the parameter 508 of the power OFF state is “unallowed”), the processing goes to step S1106. The software update management unit 216 refers to the power OFF/ON necessity 302 which is set as the update information 202.

In step S1106, the software update management unit 216 changes the update timing 602 with respect to the software module 601, which is not to be turned OFF/ON at the time of the updating, to “immediately”. In step S1106, the software update management unit 216 changes the update timing 602 with respect to the software module 601, which is required to be turned OFF/ON at the time of the updating, to “in the nighttime”. In step S1105, the software update management unit 216 further determines the update timing according to thud changed content, and the processing goes to step S706 of FIG. 7.

In step S1102, as described above, if the software update management unit 216 determines that the parameter 512 of the use frequency is set (YES in step S1102), the processing goes to step S1107. The software update management unit 216 refers to the use frequency 402 of the function use frequency data 213 in order to select the software module to which the use frequency which has a value equal to or more than the parameter 512 of the use frequency set as the update setting information 215.

Still further, the software update management unit 216 selects, if there is a software module which is required to be updated concurrently with the selected software module, the software module from the update information 202. The software update management unit 216 changes the update timing 602 with respect to the selected software module 601 to “immediately”. In step S1107, on the other hand, the software update management unit 216 changes the update timing 602 with respect to the non-selected software module 601 to “in the nighttime”.

Then, the software update management unit 216 refers to the power OFF/ON necessity 302 that is set as the update information 202. In step S1108, based on the reference result, the software update management unit 216 determines whether or not there is a software module which needs to be turned OFF/ON at the time of the updating, in the software modules in which update timings 602 were set to “immediately” in step S1107.

As a result of the determination, if there is no software module which needs to be turned OFF/ON (NO in step S1108), the processing goes to step S1105. In step S1105, the software update management unit 216 fixes the update timing according to the content which was changed in step S1107 and the processing goes to step S706 of FIG. 7.

On the other hand, if there is a software module which needs to be turned OFF/ON (YES in step S1108), the processing goes to step S1109. In step S1109, the software update management unit 216 determines whether or not the parameter 508 of the power OFF state that is set as the update setting information 215 is set to “allowed”.

As a result of the determination, if the parameter 508 of the power OFF state is “allowed” (YES in step S1109), the processing goes to step S1110 since all the software modules can be immediately updated at the timing at which the software modules are turned OFF/ON. In step S1110, the software update management unit 216 changes the update timings 602 with respect to all the software modules 601 of the update timing information 217, to “immediately”. In step S1105, the software update management unit 216 fixes the update timings according to thus changed content and the processing goes to step S706 of FIG. 7.

On the other hand, if the parameter 508 of the power OFF state is not “allowed” (i.e., “unallowed”) (NO in step S1109), the processing goes to step S1111. Then, the software update management unit 216 refers to the power OFF/ON necessity 302 that is set as the update information 202. In step S1111, as the reference result, the software update management unit 216 changes the update timing 602 with respect to the software module 601 which needs to be turned OFF/ON at the time of the updating, to “in the nighttime”. In step S1105, the software update management unit 216 fixes the update timing according to the content thus changed in steps S1107 and S1111 and the processing goes to step S706 of FIG. 7.

In step S1101, as described above, if the software update management unit 216 determines that the parameter 510 indicating the degree of urgency is set (YES in step S1101), the processing goes to step S1112. In step S1112, the software update management unit 216 determines whether or not the parameter 512 of the use frequency is set as the update setting information 215.

As a result of the determination, if the parameter 512 indicative of the use frequency is not set (NO in step S1112), the processing goes to step S1113. Then, the software update management unit 216 refers to the degree of urgency 303 of the update information 202 in order to select the software module to which a degree of urgency equal to or more than the parameter 510 of the degree of urgency is set as the update setting information 215. Further, if there is a software module which is required to be updated concurrently with thus selected software module (YES in step S1112), the software update management unit 216 selects the software module from the update information 202.

Subsequently, the software update management unit 216 changes the update timing 602 with respect to thus selected software module 601 to “immediately”. In step S1113, on the other hand, the software update management unit 216 changes the update timings 602 with respect to the software modules 601, which were not selected, to “in the nighttime”. Then, the processing goes to step S1108. In step S1105, the software update management unit 216 fixes the update timing according to the content changed in steps S1113, S1110 and S1111 in this case.

In step S1112, on the other hand, if the parameter 512 indicating the use frequency is set (YES in step S1112), the processing goes to step S1114. The software management unit 216, subsequently, refers to the degree of urgency 303 of the update information 202 in order to select the software module to which the degree of urgency of a value equal to or more than the parameter 510 of the urgency degree is set as the update setting information 215. Further, the software update management unit 216 selects, if there is a software module which is required to be updated concurrently with thus selected software module, the software module from the update information 202.

The software update management unit 216 changes the update timing 602 with respect to thus selected software module 601 to “immediately”. On the other hand, the software update management unit 216 changes the update timing 602 with respect to the software modules 601, which were not selected, to “in the nighttime”.

Further, the software update management unit 216 refers to the use frequency 402 of the function use frequency data 213. The software update management unit 216 selects the software module 601 to which the use frequency equal to or more than the use frequency parameter 512 is not set as the update setting information 215, from among the software modules about which update timings 602 were changed to “immediately”. The software update management unit 216 changes the update timing 602 with respect to thus selected software module 601 to “in the nighttime” again. Then, the processing goes to the above described step S1108. In step S1105, the update timing is fixed according to the content which was changed in step S1114, S1110 and S1111 in this case, respectively.

In an example illustrated in FIG. 10, the processing in the flow chart of FIG. 11 is as described below.

The processing goes to step S1112. In step S1112, the software update management unit 216 determines the parameter 1008 as YES in step S1101 because the parameter 1008 of the urgency degree is set “high”. Then, the processing goes to step S1113. In step S1113, the software update management unit 216 determines the parameter 1009 as NO in step S1112 because the parameter 1009 of the use frequency is set to “-” (ignored). In step S1113, the software update management unit 216 selects the software module about which parameter of the urgency degree is set equal to or more than “high”, from the urgency degree 303 of the update information 202. In the example illustrated in FIG. 10, the software modules A through D, respectively, has the parameter of the urgency degree equal to or more than “high”. Therefore, the update timings 602 with respect to the modules A through D are changed to “immediately” and the update timings 602 of the remaining modules E and F are changed to “in the nighttime”.

In the modules A through D about which update timings 602 are changed to “immediately”, there is the module D as the software module which is required to be turned OFF/ON at the time of the updating. Accordingly, the software update management unit 216 determines it as YES in step S1108 and the processing goes to step S1109. The parameter 508 of the power OFF state, which is set as the update setting information 215, is set to “unallowed”, so that the software update management unit 216 determines it as NO in step S1109 and the processing goes to step S1111. The software update management unit 216 changes the update timing 602 with respect to the module D to “in the nighttime” since it is known that the module D is required to be turned OFF/ON at the time of the updating, based on the power OFF/ON necessity 302 which is set as the update information 202.

As described above, in the present exemplary embodiment, the MFP 111 counts the use frequency of the software modules that are installed in the MFP 111 to create the data of function use frequency 213. Further, the MFP 111 sets the basic policy when the software module is updated as the update setting information 215 based on the operational input by the user. In the present exemplary embodiment, as an example of the update setting information 215, “allowed” or “unallowed” of the power OFF state at the time of the updating, the urgency degree of the updating and the level of the use frequency of the software module to be updated are set.

The distribution server 101 creates the update information 202 with respect to the software module when the distribution server 101 creates the group of software modules 201. The distribution server 101 distributes the software module to be updated as well as the update information 202 with respect to the software module to the MFP 111. In the present exemplary embodiment, as the example of the update information 202, the “allowed” or the “unallowed” of the power OFF at the time of updating the software module, the urgency degree of the updating of the software module and the software module to be concurrently updated are set.

For example, the MFP 111 checks the update information 202 received from the distribution server 101 against the data of function use frequency 213 and the update setting information 215, thereby determining the timing to update the software module based on the checked result. Therefore, in the system in which the software is automatically distributed from the server to the MFP, it becomes possible to update the software module at the timing at which the user-intended update policy is reflected as much as possible. Accordingly, it becomes possible to readily update the group of software modules of the MFP under the condition desired by the user more than in the conventional art.

The present exemplary embodiment is configured such that the update timing is determined based on the update setting information 215 indicative of the basic policy at the time of the updating or such that the update timing is determined based on the manual operation by the user of the MFP 111. Consequently, the update timing for updating the software module can be more flexibly determined.

The information to be used in determining the update timing for updating the software module is not limited to the above described information. More specifically, any information can be used as long as the information indicating the policy of the updating set by the MFP 111 and the index information in determining the update timing distributed from the distribution server 101 together with the software module to be updated, are used.

For example, as the information relating to a materiality degree of the fault to be treated by this updating, information other than the urgency degree of the updating (e.g., information indicative of the materiality itself of the fault to be treated by this updating) may be used here. Further, information such as a capacity of the software module to be updated may be used here. If such information is used, for example, if the materiality of the fault or the capacity as the update information 202 is larger than the materiality of the fault or the capacity as the update setting information 215, updating of the subject software can be immediately determined.

Further, in the present exemplary embodiment, the distribution server 101 concurrently distributes the group of software modules 201 and the update information 202 to the MFP 111 to cause the MFP 111 to obtain both of the software modules and the update information 202 at the same time. However, the above described software modules and the update information 202 may be distributed and obtained at different timings.

The electronic apparatus in which the software module is to be updated may be any electronic apparatus other than the MFP 111.

Each of the units of the electronic apparatus and each of the steps of the updating method for updating the software according to the above described exemplary embodiment of the present invention can be realized by executing a program stored in a RAM or a ROM of a computer. The program and a computer readable recording medium which stores the program are encompassed within the scope of the present invention.

Further, the present invention can be achieved by an exemplary embodiment of, for example, a system, an apparatus, a method, a program or a storage medium. More specifically, the present invention may be applied to a system including a plurality of devices or may be applied to an apparatus formed into a singular device.

The present invention encompasses a case where the program of the software which realizes the function of the above described exemplary embodiment (the programs corresponding to the flowchart of each of FIGS. 7, 9 and 11 in the above described exemplary embodiment) is supplied to the system or the apparatus directly or remotely. The present invention also encompasses a case where the present invention is achieved by the system or the apparatus reading out and executing a program code of the supplied program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-020515 filed Jan. 30, 2009, which is hereby incorporated by reference herein in its entirety.

What is claimed is:

1. An electronic apparatus including a software module, comprising:
a setting unit configured to set information indicative of a policy at the time of updating the software module based on an operation by a user;
an acquirement unit configured to acquire the software module to be updated and information as an index for determining timing for updating the software module; and
a determination unit configured to determine the timing for updating the software module by using the information set by the setting unit and the information acquired by the acquirement unit.

2. The electronic apparatus according to claim 1,
wherein the acquirement unit acquires the software module as well as, as the information indicative of the policy at the time of updating the software module, information relating to a materiality degree of a fault to be treated by updating the software module and information indicating whether or not an operation of the electronic apparatus is to be once stopped in the updating, and
wherein the setting unit sets, as an index for determining the timing for updating the software module, the information relating to the materiality degree of the fault to be treated by the updating and information indicating whether or not the operation of the electronic apparatus is allowed to be once stopped in the updating.

3. The electronic apparatus according to claim 1,
wherein the acquirement unit counts a use frequency of the software module in the electronic apparatus,
wherein the setting unit further sets the use frequency of the software module to be updated based on an operation by the user, and
wherein the determination unit determines the update timing for updating the software module by using the use frequency set by the setting unit and the use frequency thus counted by the acquirement unit.

4. The electronic apparatus according to claim 3,
wherein the acquirement unit further acquires the software module and information indicative of a software module which is to be updated together with the software module, as information indicative of the policy when the software module is updated, and
wherein the determination unit causes the software module, which is to be concurrently updated, to be updated at the same timing.

5. The electronic apparatus according to claim 1, wherein the determination unit determines the update timing for updating the software module according to a result of checking the information set by the setting unit against the information acquired by the acquirement unit.

6. A method for updating software which updates a software module installed in an electronic apparatus, the method comprising:
setting information indicative of a policy for updating the software module based on an operation by a user;
acquiring the software module to be updated and information that serves as an index for determining an update timing in updating the software module; and
determining the timing for updating the software module by using the set information and the acquired information.

7. A storage medium which stores a computer program, comprising:
causing a computer to execute each of steps of a method for updating software according to claim 6.
